(19) United States
(12) Patent Application Publication
(10) Pub. No.: US 2011/0063650 A1
(43) Pub. Date: Mar. 17, 2011

(54) PRINTING SYSTEM AND METHOD

(75) Inventor: Takeshi Arihara, Shizuoka (JP)

(73) Assignee: TOSHIBA TEC KABUSHIKI KAISHA, Tokyo (JP)

(21) Appl. No.: 12/868,979

(22) Filed: Aug. 26, 2010

(30) Foreign Application Priority Data
Sep. 16, 2009 (JP) 2009-214871

(51) Int. Cl. G06K 15/02

(52) U.S. Cl. 358/1.14

(57) ABSTRACT

A printing system includes a terminal device and a printer device. The terminal device includes a generation module configured to generate image data, a computation module configured to compute check digit data based on the image data, and a transmission module configured to append the check digit data to the image data and transmit the image data with the check digit data appended. The printer device includes a receiving module configured to receive the image data and the check digit data from the terminal device, a decision module configured to decide whether the received check digit data is valid or not based on the received image data and the received check digit data, and a printing unit configured to print an image on a recording medium based on the received image data if the check digit data is determined to be valid.

### CROSS-REFERENCE TO RELATED APPLICATIONS

This application is based upon and claims the benefit of priority from Japanese Patent Application No. 2009-214871, filed on Sep. 16, 2009, the entire contents of which are incorporated herein by reference.

### FIELD

Embodiments described herein relate generally to a printing system and method for conditionally enabling a printing job instructed by a terminal device to be performed at a printer device, depending on a match between check digit data generated by the terminal and that are regenerated by the printer device.

### BACKGROUND

Techniques for detecting data errors, which may occur during data communication between the devices of a computer system, are in widespread use. In the field of data error detection, a check digit (i.e., test digit) is known as a digit that is appended to data for the detection of an error, such as a symbol error. For example, a computer system may generate a check digit for identification data, such as a bar code, student information in the school register, a bank account number, an international standard book number (ISBN), etc., append the check digit to the data and after the process of transmitting or inputting the data, regenerate a check digit based on the received or inputted data to determine whether the received or inputted data is in a normal state or not.

### BRIEF DESCRIPTION OF THE DRAWINGS

FIG. 1 is a block diagram showing an illustrative embodiment of a printing system.

FIG. 2 is a block diagram showing illustrative embodiments of a terminal device and a printer device included in the printing system.

FIG. 3 is a flowchart showing an illustrative embodiment of a process of generating check digit data in the terminal device of the printing system.

FIG. 4 is a flowchart showing an illustrative embodiment of a process of regenerating check digit data in the printer device of the printing system.

### DETAILED DESCRIPTION

A detailed description is provided with reference to the accompanying drawings.

According to one embodiment, a printing system includes a terminal device and a printer device. The terminal device includes a generation module configured to generate image data, a computation module configured to compute check digit data based on the image data, and a transmission module configured to append the check digit data to the image data and transmit the image data with the check digit data appended. The printer device includes a receiving module configured to receive the image data and the check digit data from the terminal device, a decision module configured to decide whether the received check digit data is valid or not based on the received image data and the received check digit data, and a printing unit configured to print an image on a recording medium based on the received image data if the check digit data is determined to be valid.

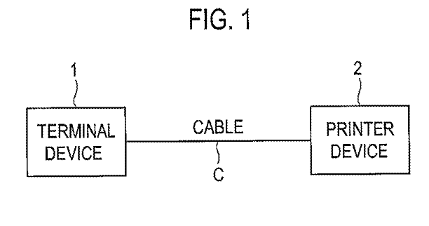

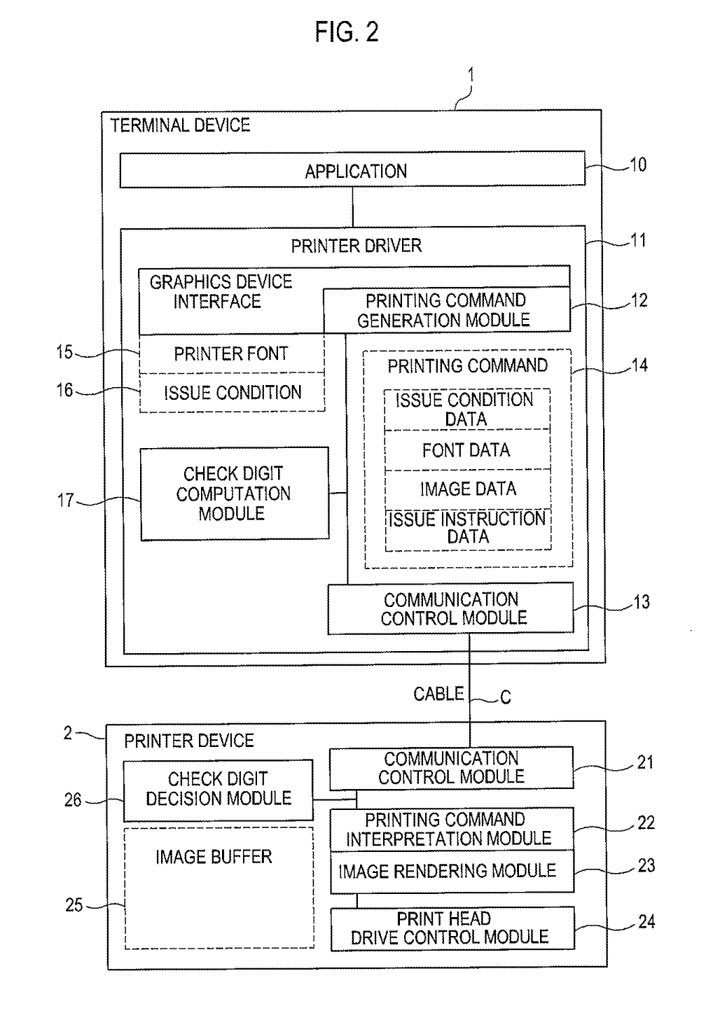

With reference to the accompanying drawings, FIG. 1 shows a block diagram of an illustrative embodiment of a printing system in accordance with one embodiment of the present disclosure and FIG. 2 shows a block diagram of illustrative embodiments of a terminal device and a printer device included in the printing system in accordance with one embodiment of the present disclosure. As shown in FIG. 1, a printing system in accordance with one embodiment of the present disclosure may include a terminal device 1 and a printer device 2 connected to the terminal device 1 through a cable C. Although the terminal device 1 and the printer device 2 are connected to each other through the cable C, they may be connected to each other through a wireless communication channel.

Referring to FIG. 2, the terminal device 1 may include an application 10 and a printer driver 11. The printer driver 11 may include a printing command generation module 12 operable to generate a printing command to instruct execution of a printing job, such as a job of printing image data, to the printer device 2. In one embodiment, the printing command may include print data, including issue condition data, font data and image data, and issue instruction data. The printer driver 11 may further include a check digit computation module 17 operable to compute check digit data. The printer driver 11 may be provided with a printer font 15 and an issue condition 16. The terminal device 1 may further include a communication control module 13 operable to communicate with the printer device 2 via the cable C, for example, to transmit a printing command 14 to the printer device 2.

The printer device 2 may include a communication control module 21 operable to receive the printing command 14 from the terminal device 1, a printing command interpretation module 22 and an image rendering module 23. The printer device 2 may further include a print head drive control module 24 operable to form a print image on a recording medium (not shown) based on image data generated in the image rendering module 23, an image buffer 25 and a check digit decision module 26.

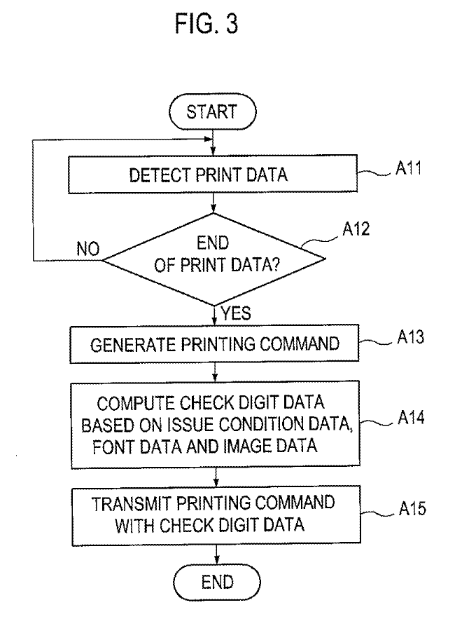

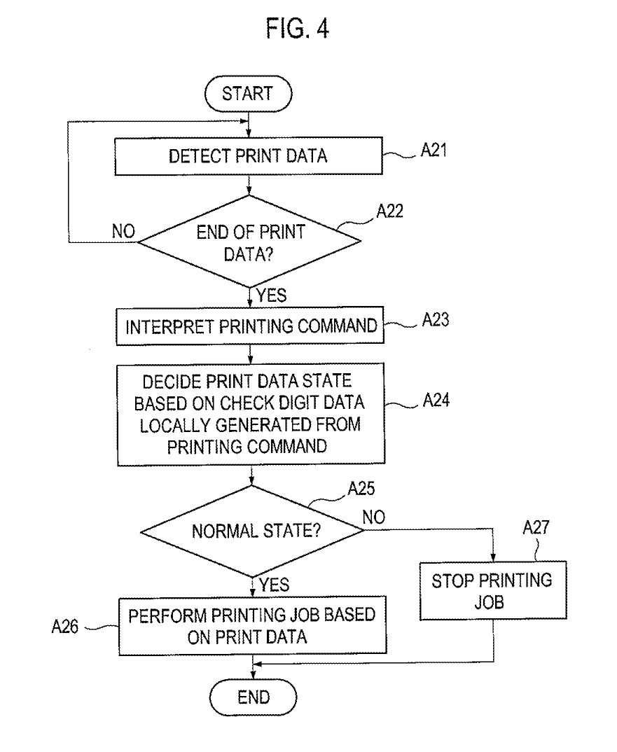

Hereinafter, a process of executing a printing job in conjunction with a check digit decision in the printing system will be described in detail. FIG. 3 shows a flowchart of an illustrative embodiment of a process of generating check digit data in the terminal device 1 of the printing system in accordance with one embodiment of the present disclosure and FIG. 4 shows a flowchart of an illustrative embodiment of a process of deciding check digit data in the printer device 2 of the printing system in accordance with one embodiment of the present disclosure.

As shown in FIG. 3, the application 10 of the terminal device 1 may detect print data (A11). The application 10 may then check whether the end of the print data is detected (A12). Upon detecting the end of the print data at the application 10, the printing command generation module 12 of the printer driver 11 may generate the printing command 14 based on the issue condition 16 and issue image data (A13). For example, the printing command 14 may include issue condition data, which indicates the issue condition 16, font data, image data and issue instruction data.

In one embodiment, in generating the printing command 14 at the printing command generation module 12, the check digit may be used. For this purpose, the check digit computation module 17 may compute check digit data that includes, for example, several bytes based on one or more of the issue condition data, the font data, and the image data (A14). By way of non-limiting example, the check digit data may be computed by performing a predetermined algorithm upon one or more of the issue condition data, the font data, and the image data.

In an exemplary embodiment, the data for use in computing the check digit data may be selected from a data set including but not limited to: all of the issue condition data, the font data and the image data; the image data only; the image data and the font data; the image data and the issue condition data; the issue condition data and the font data; the issue condition data only; and the font data only. It is noted that if deciding of check digit data in the check digit decision module 26, as will be explained hereinbelow, is performed based on the same data set as used in the computing of the check digit data at the check digit computation module 17, a check digit matching may be accomplished.

The communication control module 13 may append the generated check digit data to a predetermined portion of the issue instruction data in the printing command 14. And then, the communication module 13 may transmit the printing command 14 to the communication control module 21 of the printer device 2 (A15). In this case, the printing command 14, as transmitted to the printer device 2, may include the print data including the issue condition data, the font data and the image data, and the issue instruction data with the check digit data appended thereto.

As shown in FIG. 4, upon receiving the issue instruction data included in the printing command 14 from the terminal device 1 through the communication control module 21, the printer device 2 may perform a printing job process. In one embodiment, the communication control module 21 may detect the reception of the print data (A21) and decide whether the end of the print data in the printing command 14 is detected (A22). If it is determined that the end of the print data is detected, the printing command interpretation module 22 may interpret the issue condition data, the font data, the image data and the issue instruction data (A23). The image rendering module 23 may render the image data to the image buffer 25 based on the interpretation in the printing command interpretation module 22.

In one embodiment, in interpreting the printing command 14 at the printing command interpretation module 22, a locally generated check digit may be used. For this purpose, the check digit decision module 26 may generate check digit data that includes, for example, several bytes. For the generation of the check digit data, the check digit decision module 26 may use the same print data as used in computing the check digit data in the terminal device 1 to ensure a correct check digit matching. In one embodiment, the check digit data may be regenerated by performing the same predetermined algorithm as used in the terminal device 1 upon the print data, but the generation thereof may not be limited thereto. For example, only a portion of the print data may be used in generating the check digit data in the check digit decision module 26.

After the image rendering module 23 completes the rendering of the image data and before the print head drive control module 24 is about to start the printing job based on the issue instruction data, the check digit decision module 26 may decide whether the print data is in a normal state (A24). In one embodiment, the decision may be made by checking if a match is found between the locally generated check digit data with the check digit data appended to the issue instruction data in the printing command received from the terminal 1.

If it is determined at the check digit decision module 26 that the print data is in a normal state (A25), the printer device 2 may perform the printing job on a recording medium based on the print data and through the use of the print head drive control module 148 (A26). Otherwise, if it is determined that the print data is in an abnormal state, i.e., was affected by errors, the printer device 2 may not perform the printing job and optionally may issue an error message (A27). By doing so, it becomes possible to prevent incomplete printing, such as an output of blank paper, an image omission and image dislocation, due to data transmission errors, and as a result, an unnecessary printing operation can be avoided.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS (Operating System) or the like in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing system comprising:
a terminal device including a generation module configured to generate image data, a computation module configured to compute check digit data based on the image data, and a transmission module configured to append the check digit data to the image data and transmit the image data with the check digit data appended; and
a printer device including a receiving module configured to receive the image data and the check digit data from the terminal device, a decision module configured to decide whether the received check digit data is valid or not based on the received image data and the received check digit data, and a printing module configured to print an image on a recording medium based on the received image data if the check digit data is determined to be valid.

2. The printing system of claim 1, wherein the computation module of the terminal device is further configured to compute the check digit data based on issue condition data in addition to the image data.

3. The printing system of claim 1, wherein the computation module of the terminal device is further configured to compute the check digit data based on font data in addition to the image data.

4. A printing apparatus comprising:
a receiving module configured to receive image data and check digit data from an external device;
a decision module configured to decide whether the received check digit data is valid based on the image data and the check digit data received from the receiving unit; and
a printing module configured to print an image on a recording medium based on the image data if the check digit data is determined to be valid.

5. The printing apparatus of claim 4, wherein the decision module is further configured to compute the check digit data based on issue condition data in addition to the image data and based on the computed check digit data, and decide whether the received check digit data is valid.

6. The printing apparatus of claim 4, wherein the decision module is further configured to compute the check digit data based on font data in addition to the image data and based on the computed check digit data, and decide whether the received check digit data is valid.

7. A printing method comprising:
generating image data through a generation module of a terminal device;
computing check digit data through a computation module of the terminal device;
appending the check digit data to the image data through a transmitting module of the terminal device;
transmitting the image data with the check digit data appended through the transmitting module of the terminal device;
receiving the image data and the check digit data at a receiving module of a printer device from the terminal device;
deciding whether the check digit data is valid based on the image data and the check digit data received from the terminal device through a decision module of the printer device; and
printing an image on a recording medium based on the image data through a printing module of the printer device if it is determined that the check digit data is valid.

8. The printing method of claim 7, wherein computing check digit data comprises computing the check digit data based on one or more of issue condition data, font data and the image data.

9. The printing method of claim 7, wherein computing check digit data comprising computing the check digit data based on the image data.

10. The printing method of claim 8, wherein computing check digit data comprises computing the check digit data based on the issue condition data in addition to the image data.

11. The printing method of claim 8, wherein computing check digit data comprises computing the check digit data based on the font data in addition to the image data.

12. A computer-readable recording medium storing a computer program thereon, said computer program including instructions, which when run on a computer, perform the following:
generating image data through a generation module of a terminal device;
computing check digit data through a computation module of the terminal device;
appending the check digit data to the image data through a transmitting module of the terminal device;
transmitting the image data with the check digit data appended through the transmitting module of the terminal device;
receiving the image data and the check digit data at a receiving module of a printer device from the terminal device;
deciding whether the check digit data is valid based on the image data and the check digit data received from the terminal device through a decision module of the printer device; and
printing an image on a recording medium based on the image data through a printing module of the printer device if it is determined that the check digit data is valid.

13. The computer-readable recording medium of claim 12, wherein computing check digit data comprises computing the check digit data based on one or more of issue condition data, font data and the image data.

14. The computer-readable recording medium of claim 12, wherein computing check digit data comprises computing the check digit data based on the image data.

15. The computer-readable recording medium of claim 14, wherein computing check digit data comprises computing the check digit data based on issue condition data in addition to the image data.

16. The computer-readable recording medium of claim 14, wherein computing check digit data comprises computing the check digit data based on font data in addition to the image data.
